(19) United States
(12) Patent Application Publication
(10) Pub. No.: US 2009/0151318 A1
(43) Pub. Date: Jun. 18, 2009

(54) SYSTEM AND METHOD FOR REGENERATING AN ABSORBENT SOLUTION

(75) Inventors: Nareshkumar B. Handagama, Knoxville, TN (US); Rasesh R. Kotdawala, Knoxville, TN (US); David G. Turek, South Windsor, CT (US); Gregory N. Liljedahl, Tarrifville, CT (US); Allen M. Pfeffer, Windsor Locks, CT (US); Wei Zhang, West Hartford, CT (US)

Correspondence Address: Michaud-Duffy Group LLP, 306 Industrial Park Road, Suite 206, Middletown, CT, 06457, US

(73) Assignee: ALSTOM TECHNOLOGY LTD, Baden (CH)

(21) Appl. No.: 12/277,935

(22) Filed: Nov. 25, 2008

Related U.S. Application Data
(60) Provisional application No. 61/013,369, filed on Dec. 13, 2007.

(51) Int. Cl. F02C 6/00

(52) U.S. Cl. 60/39.182

(57) ABSTRACT

A system (100) for regenerating an absorbent solution, including: steam (128) produced by a boiler (130); a set of pressure turbines (132) fluidly coupled to the boiler; a siphoning mechanism (134) for siphoning at least a portion of the steam produced by the boiler; and a regenerating system (118) fluidly coupled to the siphoning mechanism, wherein siphoned steam is utilized as a heat source for the regenerating system.

### CROSS-REFERENCE TO RELATED APPLICATION

This application claims priority benefit under 35 U.S.C. §119(e) of copending U.S. Provisional Patent Application Ser. No. 61/013,369 filed Dec. 13, 2007, which is hereby incorporated by reference in its entirety.

### BACKGROUND OF THE INVENTION

1. Field of the Invention

The disclosed subject matter relates to a system and method for regenerating an absorbent solution utilized in absorbing an acidic component from a process stream. More specifically, the disclosed subject matter relates to a system and method for utilizing steam produced by the combustion of a fuel to regenerate an absorbent solution.

2. Description of Related Art

Process streams, such as waste streams from coal combustion furnaces, often contain various components that must be removed from the process stream prior to its introduction into an environment. For example, waste streams often contain acidic components, such as carbon dioxide (CO₂) and hydrogen sulfide (H₂S), that must be removed or reduced before the waste stream is exhausted to the environment.

One example of an acidic component found in many types of process streams is carbon dioxide. Carbon dioxide (CO₂) has a large number of uses. For example, carbon dioxide can be used to carbonate beverages, to chill, freeze and package seafood, meat, poultry, baked goods, fruits and vegetables, and to extend the shelf-life of dairy products. Other uses include, but are not limited to treatment of drinking water, use as a pesticide, and an atmosphere additive in greenhouses. Recently, carbon dioxide has been identified as a valuable chemical for enhanced oil recovery where a large quantity of very high pressure carbon dioxide is utilized.

One method of obtaining carbon dioxide is purifying a process stream, such as a waste stream, e.g., a flue gas stream, in which carbon dioxide is a byproduct of an organic or inorganic chemical process. Typically, the process stream containing a high concentration of carbon dioxide is condensed and purified in multiple stages and then distilled to produce product grade carbon dioxide.

The desire to increase the amount of carbon dioxide removed from a process gas is fueled by the desire to increase amounts of carbon dioxide suitable for the above-mentioned uses (known as “product grade carbon dioxide”) as well as the desire to reduce the amount of carbon dioxide released to the environment upon release of the process gas to the environment. Process plants are under increasing demand to decrease the amount or concentration of carbon dioxide that is present in released process gases. At the same time, process plants are under increasing demand to conserve resources such as time, energy and money. The disclosed subject matter may alleviate one or more of the multiple demands placed on process plants by decreasing the amount of energy required to remove the carbon dioxide from the process gas.

### SUMMARY OF THE INVENTION

According to aspects illustrated herein, there is provided a process for providing at least a portion of steam produced by a boiler to a regenerating system, said process comprising: producing a steam by combusting a fuel source in a boiler; providing at least a portion of said steam to a set of pressure turbines fluidly coupled to said boiler, said set of pressure turbines including a high pressure turbine, an intermediate pressure turbine, a low pressure turbine and a back pressure turbine; siphoning at least a portion of said steam provided to said set of pressure turbines through a siphoning mechanism to produce siphoned steam, wherein said siphoning mechanism is located at a position selected from a group consisting of a position between said boiler and said high pressure turbine, a position between said high pressure turbine and said intermediate pressure turbine, a position between said intermediate pressure turbine and said low pressure turbine, and combinations thereof; utilizing said siphoned steam as a heat source for a regenerating system fluidly coupled to said siphoning mechanism.

According to another aspect illustrated herein, there is provided a system for regenerating an absorbent solution, said system comprising: steam produced by a boiler; a set of pressure turbines fluidly coupled to said boiler, said set of pressure turbines including a high pressure turbine, an intermediate pressure turbine, a low pressure turbine and a back pressure turbine; a siphoning mechanism for siphoning at least a portion of said steam produced by said boiler, wherein said siphoning mechanism is located at a position selected from a group consisting of a position between said boiler and said high pressure turbine, a position between said high pressure turbine and said intermediate pressure turbine, a position between said intermediate pressure turbine and said low pressure turbine, and combinations thereof; a regenerating system fluidly coupled to said siphoning mechanism, wherein siphoned steam is utilized as a heat source for said regenerating system.

According to another aspect illustrated herein there is provided a system for regenerating an absorbent solution, the system comprising a first boiler generating a process stream and steam, an absorber for removing an acidic component from said process stream thereby forming a rich absorbent solution and a cleansed process stream, and a regenerator for regenerating said rich absorbent solution, the improvement comprising: a second boiler generating steam; and a reboiler coupled to said regenerator, wherein at least a portion of steam from said second boiler is provided to said reboiler.

The above described and other features are exemplified by the following figures and detailed description.

### BRIEF DESCRIPTION OF THE DRAWINGS

Referring now to the figures, which are exemplary embodiments, and wherein the like elements are numbered alike:

FIG. 1 is a diagram depicting an example of one embodiment of a system for removing at least a portion of an acidic component from a process stream;

FIG. 2 is a diagram depicting an example of another embodiment of a system for removing at least a portion of an acidic component from a process stream;

FIG. 3 is a diagram depicting an example of another embodiment of a system for removing at least a portion of an acidic component from a process stream;

FIG. 4 is a diagram depicting an example of another embodiment of a system for removing at least a portion of an acidic component from a process stream;

FIG. 5 is a diagram depicting an example of another embodiment of a system for removing at least a portion of an acidic component from a process stream;

FIG. 6 is a diagram depicting an example of another embodiment of a system for removing at least a portion of an acidic component from a process stream; and

FIG. 7 is a diagram depicting an example of another embodiment of a system for removing at least a portion of an acidic component from a process stream.

### DETAILED DESCRIPTION OF PREFERRED EMBODIMENTS

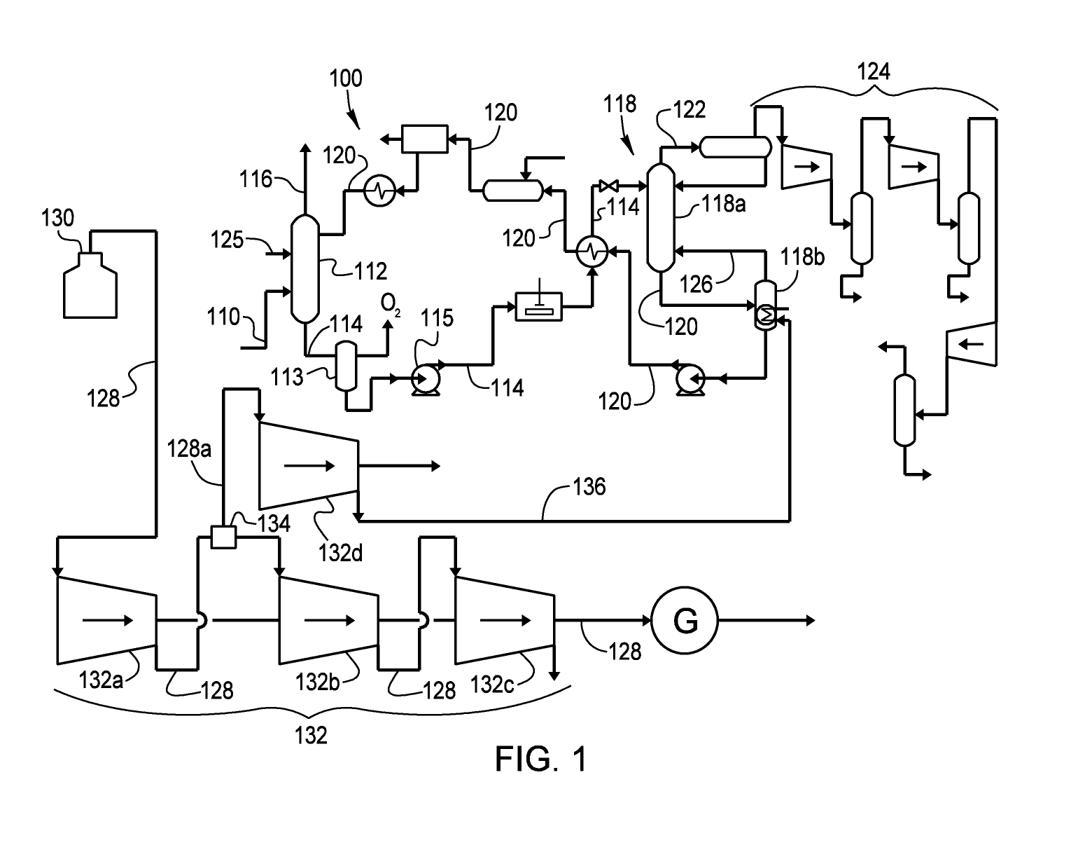

FIGS. 1-5 illustrate a system 100 for absorbing an acidic component from a process stream 110. In one embodiment, the process stream 110 may be any liquid stream such as, for example, natural gas streams, synthesis gas streams, refinery gas or liquid streams, output of petroleum reservoirs, or streams generated from combustion of materials such as coal, natural gas or other fuels. One example of process stream 110 is a flue gas stream generated by combustion of a fuel such as, for example, coal, and provided at an output of a combustion chamber of a fossil fuel fired boiler. Examples of other fuels include, but are not limited to natural gas, synthetic gas (syngas), and petroleum refinery gas. Depending on the type of or source of the process stream, the acidic component(s) may be in a gaseous, liquid or particulate form.

In one embodiment, the process stream 110 contains several acidic components including, but not limited to, carbon dioxide. By the time the process stream 110 enters an absorber 112, the process stream 110 may have undergone treatment to remove particulate matter (e.g., fly ash), as well as sulfur oxides (SOx) and nitrogen oxides (NOx). However, processes may vary from system to system and therefore, such treatments may occur after the process stream 110 passes through the absorber 112, or not at all.

The absorber 112 employs an absorbent solution (disposed therein) that facilitates the absorption and the removal of a gaseous component from the process stream 110. In one embodiment, the absorbent solution includes a chemical solvent and water, where the chemical solvent contains, for example, a nitrogen-based solvent and, in particular, primary, secondary and tertiary alkanolamines; primary and secondary amines; sterically hindered amines; and severely sterically hindered secondary aminoether alcohols. Examples of commonly used chemical solvents include, but are not limited to: monoethanolamine (MEA), diethanolamine (DEA), diisopropanolamine (DIPA), N-methylethanolamine, triethanolamine (TEA), N-methyldiethanolamine (MDEA), piperazine, N-methylpiperazine (MP), N-hydroxyethylpiperazine (HEP), 2-amino-2-methyl-1-propanol (AMP), 2-(2-aminoethoxy)ethanol (also called diethyleneglycolamine or DEGA), 2-(2-tert-butylaminopropoxy)ethanol, 2-(2-tert-butylaminoethoxy)ethanol (TBEE), 2-(2-tert-amylaminoethoxy)ethanol, 2-(2-isopropylaminopropoxy)ethanol, 2-(2-(1-methyl-1-ethylpropylamino)ethoxy)ethanol, and the like. The foregoing may be used individually or in combination, and with or without other co-solvents, additives such as anti-foam agents, buffers, metal salts and the like, as well as corrosion inhibitors. Examples of corrosion inhibitors include, but are not limited to heterocyclic ring compounds selected from the group consisting of thiomopholines, dithianes and thioxanes wherein the carbon members of the thiomopholines, dithianes and thioxanes each have independently H, C₁₋₈ alkyl, C₇₋₁₂ alkaryl, C₆₋₁₀ aryl and/or C₃₋₁₀ cycloalkyl group substituents; a thiourea-amine-formaldehyde polymer and the polymer used in combination with a copper (II) salt; an anion containing vanadium in the plus 4 or 5 valence state; and other known corrosion inhibitors.

In one embodiment, the absorbent solution present in the absorber 112 is referred to as a “lean” absorbent solution and/or a “semi-lean” absorbent solution 120. The lean and semi-lean absorbent solutions are capable of absorbing the acidic component from the process stream 110, e.g., the absorbent solutions are not fully saturated or at full absorption capacity. As described herein, the lean absorbent solution is more absorbent than the semi-lean absorbent solution. In one embodiment, described below, the lean and/or semi-lean absorbent solution 120 is provided by the system 100. In one embodiment, a make-up absorbent solution 125 is provided to the absorber 112 to supplement the system provided lean and/or semi-lean absorbent solution 120.

Absorption of the acidic component from the process stream 110 occurs by contact between the lean and/or semi-lean absorbent solution 120 and the process stream 110. As will be appreciated, contact between the process stream 110 and the lean and/or semi-lean absorbent solution 120 can occur in any manner in absorber 112. In one example, the process stream 110 enters a lower portion of absorber 112 and travels up a length of the absorber 112 while the lean and/or semi-lean absorbent solution 120 enters the absorber 112 at a location above where the process stream 110 enters the absorber 112, and the lean and/or semi-lean absorbent solution 120 flows in a countercurrent direction of the process stream 110.

Contact within the absorber 112 between the process stream 110 and the lean and/or semi-lean absorbent solution 120 produces a rich absorbent solution 114 from the lean or semi-lean absorbent solution 120. In one example, the rich absorbent solution 114 falls to the lower portion of absorber 112, where it is removed for further processing, while the process stream 110 having a reduced amount of acidic component travels up a length of the absorber 112 and is released as a stream 116 from a top portion of the absorber 112.

The rich absorbent solution 114 exits the absorber 112 and is provided to a regenerating system shown generally at 118. The rich absorbent solution 114 may travel to the regenerating system 118 via a treatment train that includes, but is not limited to, flash coolers 113, pumps 115 and heat exchangers, as described below.

The regenerating system 118 includes, for example, several devices or sections, including, but not limited to, a regenerator 118a and a reboiler 118b. The regenerator 118a regenerates the rich absorbent solution 114, thereby producing the lean and/or semi-lean absorbent solution 120 as well as a stream of acidic component 122. As shown in FIGS. 1-5, the stream of the acidic component 122 may be transferred to a compressing system shown generally at 124, which condenses and compresses the acidic component for storage and further use. The lean and/or semi-lean absorbent 120 is transferred via a treatment train (including pumps, heat exchangers and the like) to the absorber 112 for further absorption of an acidic component from the process stream 110.

As illustrated in FIG. 1, the reboiler 118b provides a steam 126 to the regenerator 118a. The steam 126 regenerates the rich absorbent solution 114, thereby producing the lean and/or semi-lean absorbent solution 120.

In another embodiment, system 100 employs a process, or technology, referred to as “the chilled ammonia process”. In this embodiment, the absorbent solution in absorber 112 is a solution or slurry including ammonia. The ammonia can be in the form of ammonium ion, NH₄⁺ or in the form of dissolved molecular NH₃. The absorption of the acidic component present in process stream 110 is achieved when the absorber 112 is operated at atmospheric pressure and at a low temperature, for example, between zero and twenty degrees Celsius (0-20° C.). In another example, absorption of the acidic component from process stream 110 is achieved when the absorber 112 is operated at atmospheric pressure and at a temperature between zero and ten degrees Celsius (0-10° C.).

Absorption of the acidic component by an ammonia containing solution produces a rich absorbent solution 114, which is removed from the absorber 112 for further processing. The rich absorbent solution 114 exits the absorber 112 and is provided to a regenerating system 118. In one example, prior to being provided to regenerating system 118, the pressure of the rich absorbent 114 is elevated by a pump 115 to the range of thirty to two thousand pounds per square inch (30-2000 psi). The rich absorbent solution 114 is provided to the regenerator 118a and is heated to a temperature range of fifty to two hundred degrees Celsius (50-200° C.), thereby regenerating the rich absorbent solution 114. The regenerated rich absorbent solution is then provided to the absorber 112 as the lean or semi-lean absorbent solution 120 that includes ammonia.

As shown in FIGS. 1-5, a steam 128 from a boiler 130 is utilized as a heat source to generate the steam 126. The steam 128 may be produced by combustion of a fuel, such as a fossil fuel, in the boiler 130.

In one example, the steam 128 is transferred from the boiler 130 to a set of pressure turbines 132. The set of pressure turbines saturates the steam prior to the steam being supplied to regenerating system 118.

As illustrated in FIG. 1, in one embodiment, the set of pressure turbines 132 may include, for example, a high pressure turbine 132a, an intermediate pressure turbine 132b, a low pressure turbine 132c and a back pressure turbine 132d. However, it is contemplated that the set of pressure turbines 132 may include only one or a few of the above-mentioned turbines. Steam 128 leaves the set of pressure turbines 132 and proceeds to a generator G for further use, such as the production of electricity.

As should be appreciated, the configuration of the set of pressure turbines 132 may vary from system to system, with the various pressure turbines being fluidly coupled to one another as well as to the boiler 130 and the regenerating system 118. The term “fluidly coupled” as used herein, means the device is in communication with, or is connected to, either directly (nothing between the two devices) or indirectly (something present between the two devices), another device by pipes, conduits, conveyors, wires, or the like.

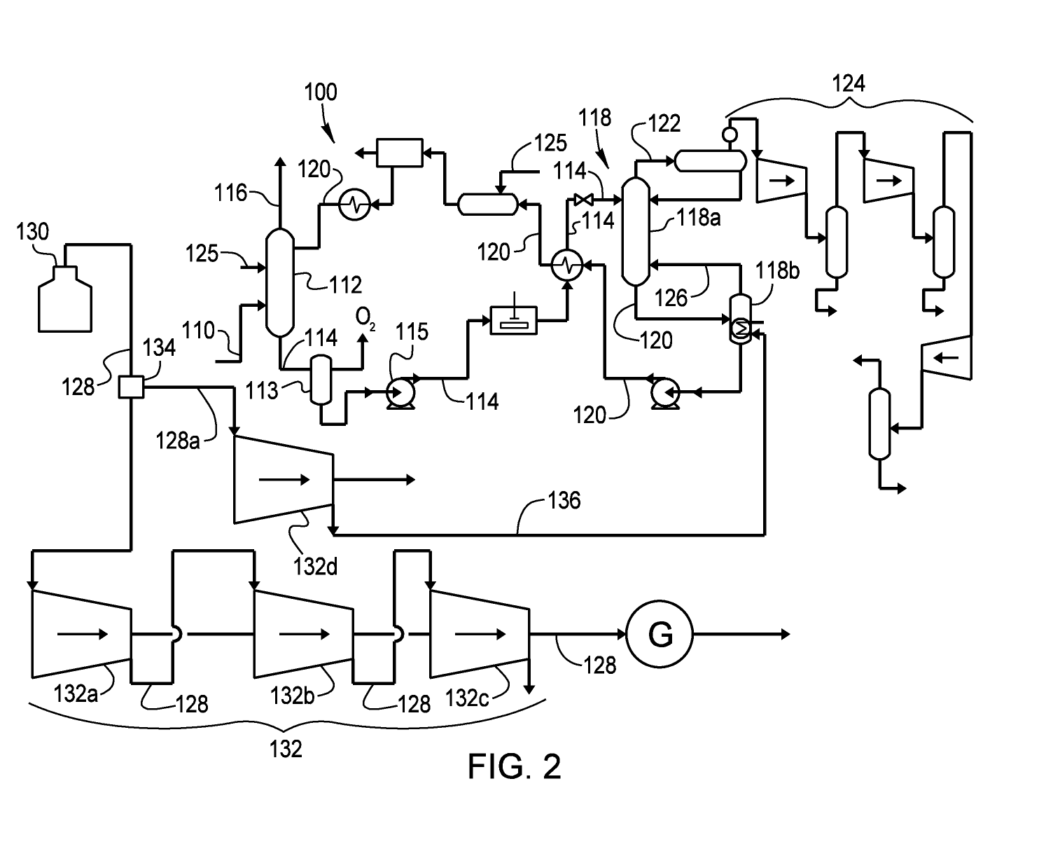

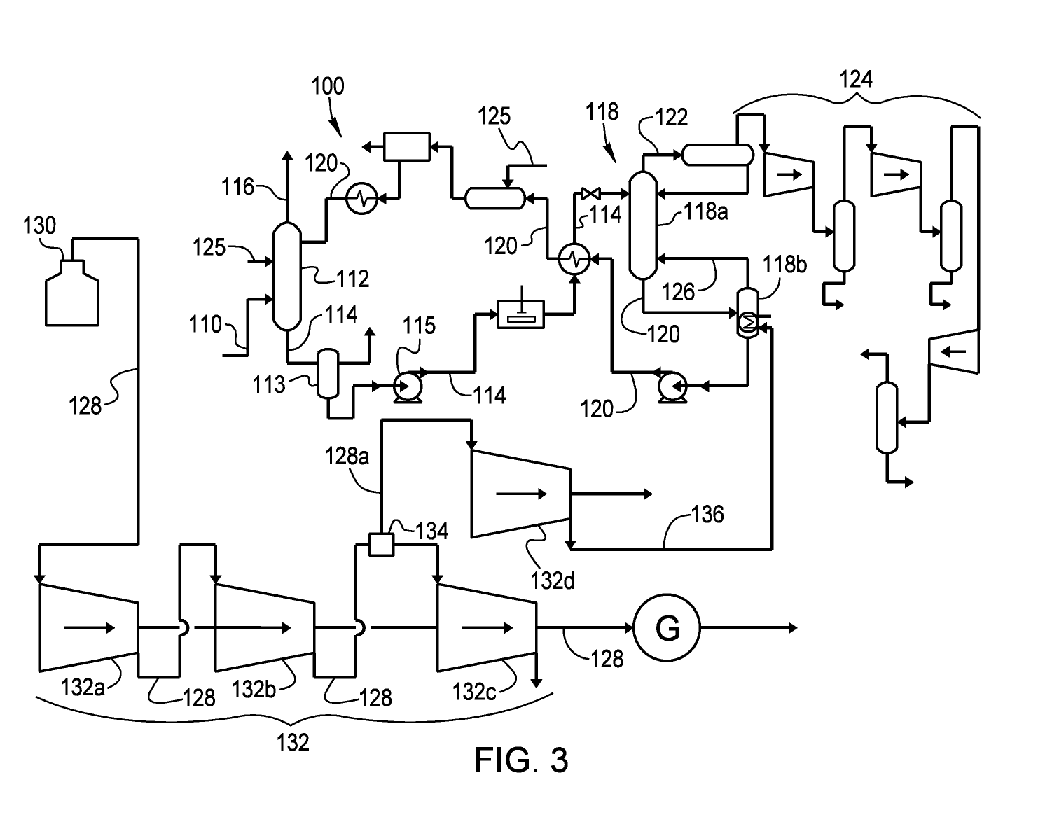

As shown in FIG. 1, high pressure turbine 132a is fluidly coupled to the boiler 130 as well as both the intermediate pressure turbine 132b and back pressure turbine 132d, while the intermediate pressure turbine 132b is fluidly coupled to low pressure turbine 132c. However, in another example as shown in FIG. 2, the boiler 130 may be fluidly coupled to the back pressure turbine 132d and the high pressure turbine 132a, while the intermediate pressure turbine 132b is fluidly coupled to the high pressure turbine 132a and the low pressure turbine 132c. In yet another example, as shown in FIG. 3, the boiler 130 is fluidly coupled to high pressure turbine 132a, which is in turn fluidly coupled to the intermediate pressure turbine 132b, which is in turn is fluidly coupled to both the back pressure turbine 132d and the low pressure turbine 132c.

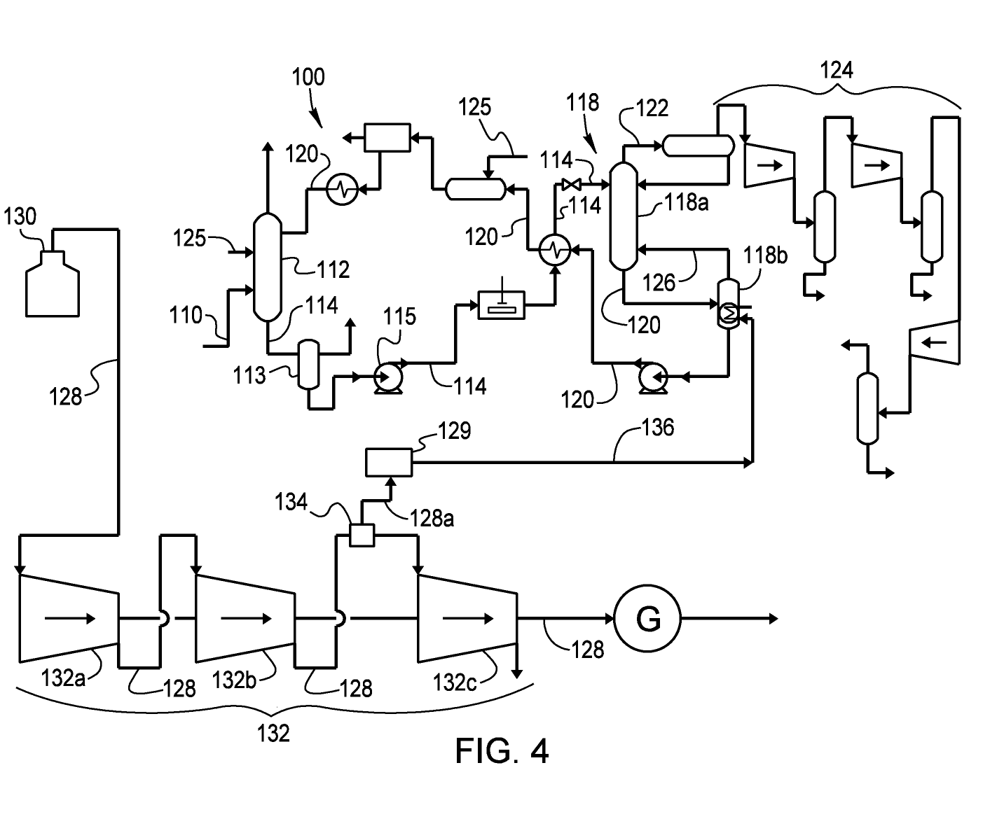

Another example, as shown in FIG. 4, includes the set of pressure turbines 132 having the high pressure turbine 132a, the intermediate pressure turbine 132b and the low pressure turbine 132c. In this example, the boiler 130 is fluidly coupled to the high pressure turbine 132a, which in turn is fluidly coupled to the intermediate pressure turbine 132b, which in turn is fluidly coupled to the reboiler 118b as well as the low pressure turbine 132c.

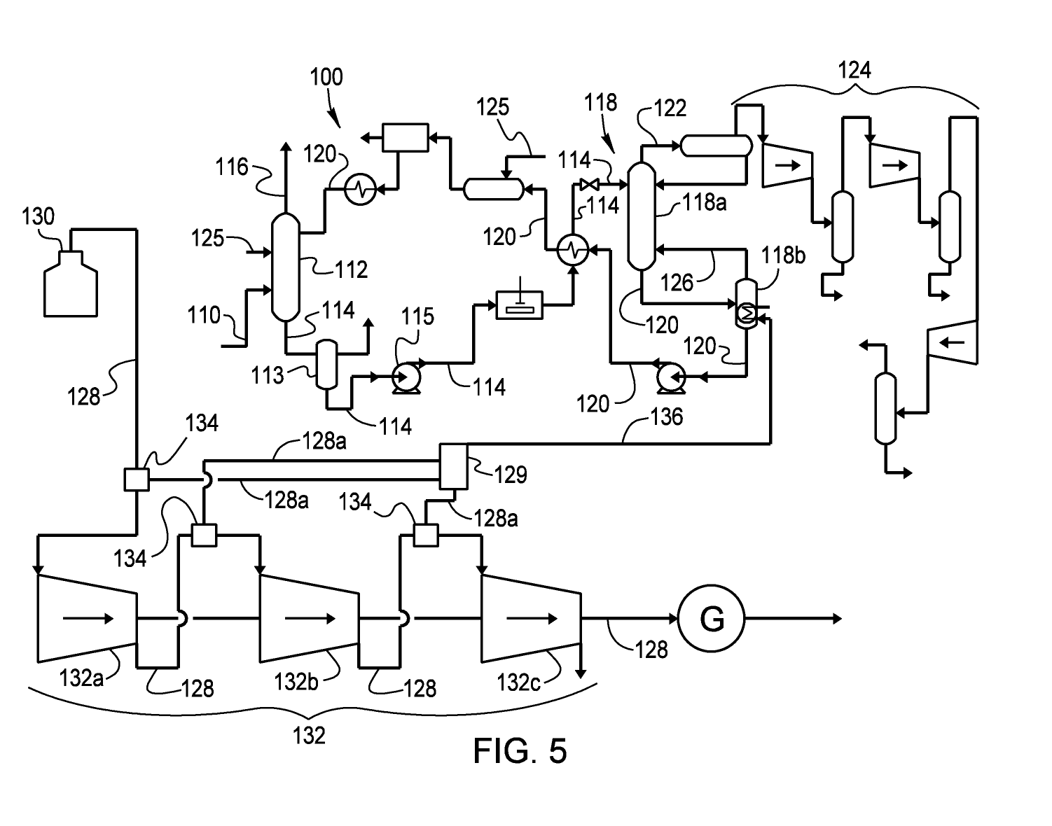

In still another example of a configuration of the set of pressure turbines 132, as shown in FIG. 5, the boiler 130 is fluidly coupled to both the high pressure turbine 132a as well as the regenerating system 118. The high pressure turbine 132a is fluidly coupled to both the regenerating system 118 and the intermediate pressure turbine 132b. The intermediate pressure turbine 132b is fluidly coupled to both the regenerating system 118 and the low pressure turbine 132c. It should be appreciated that other configurations of the set of pressure turbines 132 are contemplated, but not illustrated in the attached figures.

In one embodiment, a siphoning mechanism 134 is provided for siphoning the steam 128 to form a siphoned steam 128a. The steam siphoned from the boiler 130 or the set of pressure turbines 132 may be utilized as a heat source for the regenerating system 118. The steam that is siphoned and provided to and utilized by regenerating system 118 is typically a saturated steam, i.e., a pure steam at the temperature of the boiling point, which corresponds to its pressure and holds all of the moisture in vapor form and does not contain any liquid droplets.

In one embodiment, the steam siphoned from the boiler 130 or the set of pressure turbines 132 is utilized as a heat source for the reboiler 118b. It should be appreciated that the siphoning mechanism 134 may be any mechanism that transfers at least a portion of the steam 128 from one device to another. Examples of suitable siphoning mechanisms include, but are not limited to valves, pipes, conduits, side draws, or other devices that facilitate the transfer of steam 128.

The siphoning mechanism 134 may be located at one or more positions in system 100. In one example, as shown in FIG. 1, the siphoning mechanism 134 is located at a position between the high pressure turbine 132a and the intermediate pressure turbine 132b. In a system according to the configuration provided in FIG. 1, the steam 128 is provided from the boiler 130 to the high pressure turbine 132a. After passing through the high pressure turbine 132a, the steam 128 is transferred to the intermediate pressure turbine 132b. At least a portion of the steam 128 that is transferred from the high pressure turbine 132a to the intermediate pressure turbine 132b is siphoned off by the siphoning mechanism 134 and is transferred as siphoned steam 128a to the back pressure turbine 132d. In the back pressure turbine 132d, the siphoned steam 128a is expanded to a temperature in a range of between eighty two and two hundred four degrees Celsius (82-204° C.) to generate a heated siphoned steam 136 having a temperature in a range of between about eighty two and two hundred four degrees Celsius (82-204° C.) that is provided to the regenerating system 118 and utilized as a heat source thereby. Heated siphoned steam 136 is generally a saturated steam.

In another example, as shown in FIG. 2, the siphoning mechanism 134 is located between the boiler 130 and the high pressure turbine 132a. In a system according to the configuration provided in FIG. 2, the steam 128 is provided by the boiler 130 to the high pressure turbine 132a. At least a portion of the steam 128 from the boiler 130 is siphoned by the siphoning mechanism 134 prior to reaching the high pressure turbine 132a and is transferred as the siphoned steam 128a to the back pressure turbine 132d. In the back pressure turbine 132d, the siphoned steam 128a is expanded to a temperature in a range of between about eighty two and two hundred four degrees Celsius (82-204° C.) to generate the heated siphoned steam 136 having a temperature in a range of between about eighty two and two hundred four degrees Celsius (82-204° C.) and having a pressure in a range of between about one and one half to twenty (1.5-20) bar that is provided to regenerating system 118 and utilized as a heat source thereby. Heated siphoned steam 136 is generally a saturated steam.

In another example, as shown in FIG. 3, the siphoning mechanism 134 is located between the intermediate pressure turbine 132b and the low pressure turbine 132c. In a system according to the configuration provided in FIG. 3, the steam 128 is provided from the boiler 130 to the high pressure turbine 132a. After passing through the high pressure turbine 132a, the steam 128 is transferred to the intermediate pressure turbine 132b, and is subsequently transferred to the low pressure turbine 132c. At least a portion of the steam 128 transferred from the intermediate pressure turbine 132b to the low pressure turbine 132c is siphoned off by the siphoning mechanism 134 and transferred as the siphoned steam 128a to the back pressure turbine 132d.

In the back pressure turbine 132d, the siphoned steam 128a is expanded to a temperature in a range of between about eighty two and two hundred four degrees Celsius (82-204° C.) to generate the heated siphoned steam 136 having a temperature in a range of between about eighty two and two hundred four degrees Celsius (82-204° C.) and having a pressure in a range of between about one and one half to 20 (1.5-20) bar that is provided to the regenerating system 118 and utilized as a heat source thereby. Heated siphoned steam 136 is generally a saturated steam.

As shown in FIGS. 1-3, the heated siphoned steam 136, which is generally saturated, is provided to the reboiler 118b, however it is contemplated that the heated siphoned steam 136 can be provided to other portions of regenerating system 118 such as, for example, the regenerator 118a.

As shown in FIG. 4, in another example, the siphoning mechanism 134 is located between the intermediate pressure turbine 132b and the low pressure turbine 132c. In a system according to the configuration shown in FIG. 4, the steam 128 is transferred from the boiler 130 to the high pressure turbine 132a and subsequently transferred to the intermediate pressure turbine 132b. The steam 128 is transferred from the intermediate pressure turbine 132b to the low pressure turbine 132c. At least a portion of the steam 128 transferred to the low pressure turbine 132c is siphoned by the siphoning mechanism 134 to form the siphoned steam 128a. As shown in FIG. 4, the siphoned steam 128a, having a temperature in a range of between about eighty two and two hundred four degrees Celsius (82-204° C.) and a pressure in a range of between about one and one half to twenty (1.5-20) bar is transferred to a de-superheating device 129, such as a water spray or feedwater exchanger, to saturate the siphoned steam and form heated siphoned steam 136. Heated siphoned steam is transferred to the regenerating system 118, where it is utilized as a heat source. As shown in FIG. 4, the heated siphoned steam 136 is provided to the reboiler 118b, however it is contemplated that the heated siphoned steam 136 can be provided to other portions of the regenerating system 118 such as, for example, the regenerator 118a.

Although not illustrated in the configurations shown in FIGS. 1-4, it is contemplated that multiple siphoning mechanisms 134 can be positioned throughout the system 100. For example, the system 100 may include the siphoning mechanism 134 located between the boiler 130 and the high pressure turbine 132a as well as a siphoning mechanism 134 located between the high pressure turbine and the intermediate pressure turbine 132b. Likewise, the system 100 may include the siphoning mechanism 134 located between the high pressure turbine 132a and the intermediate pressure turbine 132b as well as the siphoning mechanism 134 between the intermediate pressure turbine 132b and the low pressure turbine 132c.

In another example, as shown in FIG. 5, a first of the siphoning mechanisms 134 is located between the boiler 130 and the high pressure turbine 132a, another of the siphoning mechanisms is located between the high pressure turbine 132a and the intermediate pressure turbine 132b, and still another of the siphoning mechanisms is located between the intermediate pressure turbine 132b and the low pressure turbine 132c. At least a portion of the steam 128 transferred to each of the high pressure turbine 132a, the intermediate pressure turbine 132b and the low pressure turbine 132c is siphoned to form the siphoned steam 128a. The siphoned steam 128a having a temperature in a range of between about eighty two and two hundred four degrees Celsius (82-204° C.) and a pressure in a range of between about one and one half to twenty (1.5-20) bar is transferred to a de-superheating device 129, such as a water spray or feedwater exchanger, to saturate the siphoned steam and form heated siphoned steam 136. Heated siphoned steam is transferred regenerating system 118, where it is utilized as a heat source.

As shown in FIG. 5, the heated siphoned steam 136 is transferred to the reboiler 118b, however, the heated siphoned steam 136 may be transferred to other sections of the regenerating system 118 such as, for example, the regenerator 118a. It is also contemplated that the siphoned steam 128a in FIG. 5 may first be transferred to the back pressure turbine 132d prior to being transferred as the heated siphoned steam to the regenerating system 118. While not shown in FIG. 5, it should be appreciated that other variations or configurations of system 100 having multiple siphoning mechanisms are contemplated.

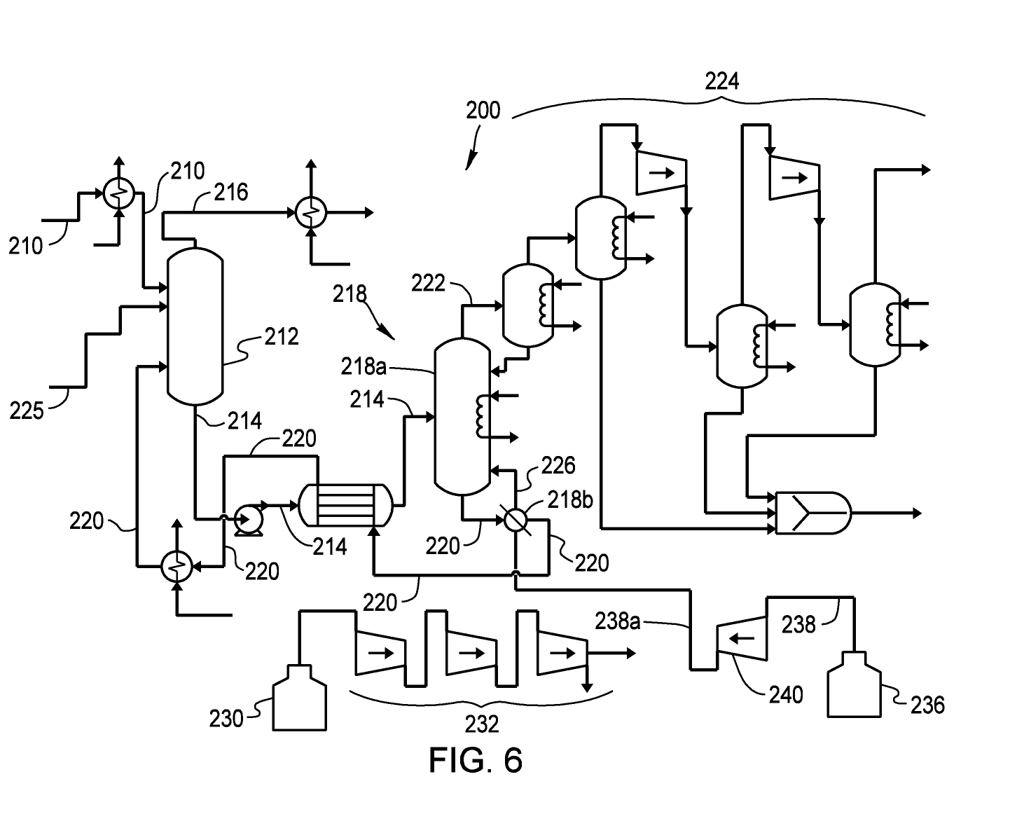

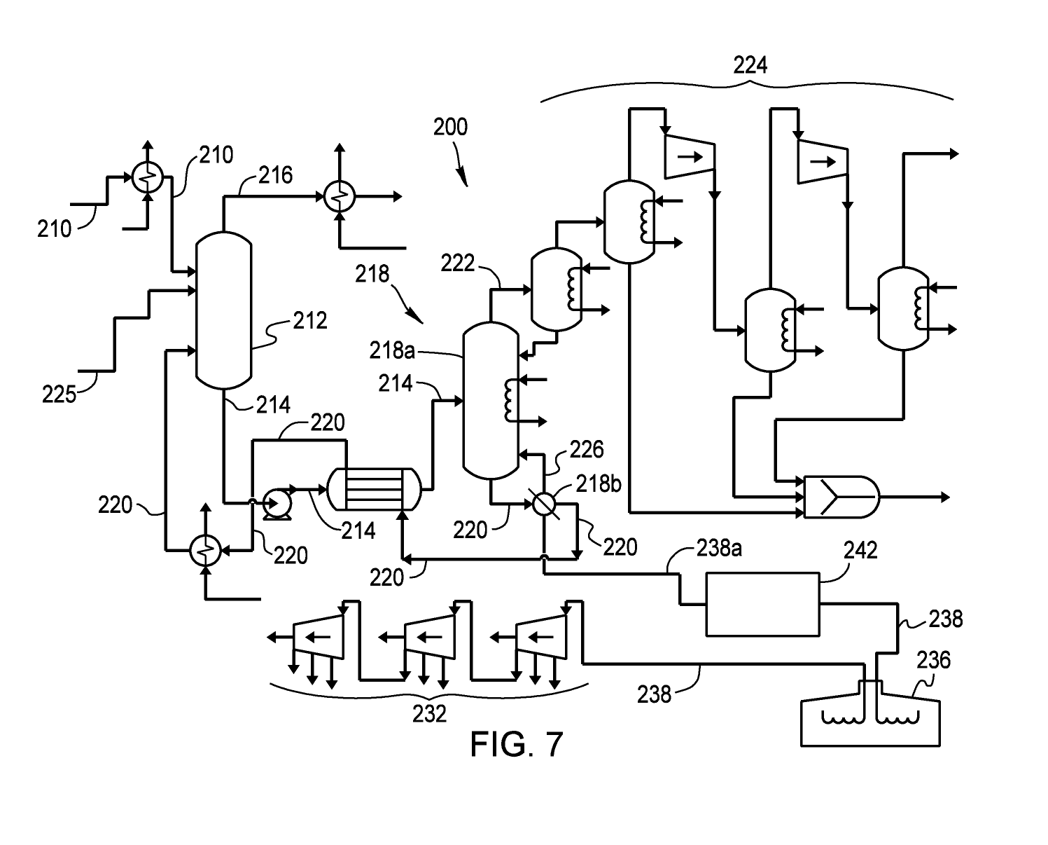

As shown in FIGS. 6 and 7, a system 200 is illustrated, wherein like numbers equal like parts as referred to in FIGS. 1-5, and reference numerals in the 200 series related to reference numerals in the 100 series. The system 200 includes a first boiler 230 and a second boiler 236. As shown in FIG. 6, the boiler 230 generates steam 228, which may or may not be provided to regenerating system 218. In FIG. 6, steam 228 is not provided to the regenerating system 218.

Still referring to FIGS. 6 and 7, the second boiler 236 generates steam 238, which is generally a saturated steam. Steam 238 is provided to a regenerating system 218 and is utilized as a heat source by the regenerating system 218. The steam 238 may be provided to any portion of the regenerating system 218. As shown in FIG. 6, the steam 238 (e.g., steam 238a) is provided to a reboiler 218b, however it is contemplated that steam 238 may be provided to regenerator 218a.

As shown in FIG. 6, the steam 238 may pass through a pressure turbine 240 prior to reaching the regenerating system 218. In the pressure turbine 240 the steam 238 may be expanded at an elevated temperature in a range of between about five hundred thirty eight and seven hundred four degrees Celsius (538-704° C.) to form a heated steam 238a. The heated steam 238a is then transferred to the regenerating system 218.

Alternatively, and as shown in FIG. 7, a portion of the steam 238 generated by the boiler 236 may be provided to a set of pressure turbines 232, while another portion of the steam 238 is provided to a steam saturator 242 prior to being transferred to the regenerating system 218 (as steam 238a) and utilized as a heat source. While not shown in FIG. 7, it is contemplated that system 200 shown therein also includes a boiler 230 for generating steam 228.

Non-limiting examples of the system(s) and process(es) described herein are provided below. Unless otherwise noted, speed is recited in kilometer per second (k/sec.), pressure is in bar, power is in megawatt electrical (MW) and temperatures are in degrees Celsius (° C.).

### EXAMPLES

### Example 1A

### System Without Utilization of Steam as Heat Source for a Regenerating System

A system configured without the use of a steam siphoned from a boiler or a set a pressure turbines is utilized to determine an amount of power generated from each of the pressure turbines. The results are provided in Table 1.

TABLE 1

| | | | | | |
|---|---|---|---|---|---|
| Pressure | Pressure | | Temp. (in) | Temp (out) | Power |
| (in) bar | (out) bar | M (k/sec) | (° C.) | (° C.) | (MW) |

High Press, Turbine

| | | | | | |
|---|---|---|---|---|---|
| 275 | 63 | 542 | 600 | 411 | 273 |
| 275 | 89.44 | 44.3 | 600 | 411 | 17 |
| 275 | 63 | 64.82 | 600 | 359 | 33 |

Inter. Press. Turbine

| | | | | | |
|---|---|---|---|---|---|
| 58.4 | 6.48 | 31.72 | 620 | 276 | 22 |
| 58.4 | 13.91 | 25.27 | 620 | 449 | 12 |
| 58.4 | 28.94 | 30.60 | 620 | 496 | 8 |
| 58.4 | 6.48 | 455.15 | 620 | 376 | 236 |

Low Press. Turbine

| | | | | | |
|---|---|---|---|---|---|
| 6.48 | .050 | 194.50 | 298 | 32.87 | 194 |
| 6.48 | .041 | 195.30 | 298 | 29.38 | 195 |
| 6.48 | .203 | 17.67 | 298 | 60 | 18 |
| 6.48 | .616 | 19.46 | 298 | 99 | 19 |
| 6.48 | 2.380 | 10.50 | 298 | 158 | 2.45 |

### Example 1B

### System With Utilization of Steam as Heat Source for a Regenerating System

A system according to the configuration illustrated in FIG. 1 is utilized to determine an amount of power generated from each of the pressure turbines and an amount of steam going to a back pressure turbine. The results are provided in Table 2.

TABLE 2

| | | | | | |
|---|---|---|---|---|---|
| Pressure | Pressure | | Temp. (in) | Temp (out) | Power |
| (in) bar | (out) bar | M (k/sec) | (° C.) | (° C.) | (MW) |

High Press, Turbine

| | | | | | |
|---|---|---|---|---|---|
| 275 | 63 | 542 | 600 | 411 | 273 |
| 275 | 89.44 | 44.3 | 600 | 411 | 17 |
| 275 | 63 | 64.82 | 600 | 359 | 33 |

Inter. Press. Turbine

| | | | | | |
|---|---|---|---|---|---|
| 58.4 | 6.48 | 31.72 | 620 | 276 | 22 |
| 58.4 | 13.91 | 25.27 | 620 | 449 | 12 |
| 58.4 | 28.94 | 30.60 | 620 | 496 | 8 |
| 58.4 | 6.48 | 255.4 | 620 | 376 | 183 |
| 58.4 (back | 5.60 | 200.00 | 620 | 363 | 109 |
| press. | | | | | |
| turbine) | | | | | |

Low Press. Turbine

| | | | | | |
|---|---|---|---|---|---|
| 6.48 | .050 | 194.50 | 298 | 32.87 | 194 |
| 6.48 | .041 | 25 | 298 | 29.38 | 20 |
| 6.48 | .203 | 10.67 | 298 | 60 | 6.71 |
| 6.48 | .616 | 19.46 | 298 | 86 | 5.71 |
| 6.48 | 2.380 | 10.50 | 298 | 158 | 2.45 |

### Example 1C

### System With Utilization of Steam as Heat Source for a Regenerating System

A system according to the configuration illustrated in FIG. 4 is utilized to determine an amount of power generated from each turbine and an amount of steam going to a back pressure turbine. The results are provided in Table 3.

TABLE 3

| | | | | | |
|---|---|---|---|---|---|
| Pressure | Pressure | | Temp. (in) | Temp (out) | Power |
| (in) bar | (out) bar | M (k/sec) | (° C.) | (° C.) | (MW) |

High Press, Turbine

| | | | | | |
|---|---|---|---|---|---|
| 275 | 63 | 542 | 600 | 411 | 273 |
| 275 | 89.44 | 44.3 | 600 | 411 | 17 |
| 275 | 63 | 64.82 | 600 | 359 | 33 |

Inter. Press. Turbine

| | | | | | |
|---|---|---|---|---|---|
| 58.4 | 6.48 | 31.72 | 620 | 276 | 22 |
| 58.4 | 13.91 | 25.27 | 620 | 449 | 12 |
| 58.4 | 28.94 | 30.60 | 620 | 496 | 8 |
| 58.4 | 6.48 | 455.15 | 620 | 376 | 236 |

Low Press. Turbine

| | | | | | |
|---|---|---|---|---|---|
| 6.48 | .050 | 250 | To the reboiler | 0 | 0 |
| 6.48 | .041 | 140 | 298 | 29.38 | 114 |
| 6.48 | .203 | 17.67 | 298 | 60 | 18 |
| 6.48 | .616 | 19.46 | 298 | 99 | 19 |
| 6.48 | 2.380 | 10.50 | 298 | 158 | 2.45 |

Unless otherwise specified, all ranges disclosed herein are inclusive and combinable at the end points and all intermediate points therein. The terms “first,” “second,” and the like, herein do not denote any order, sequence, quantity, or importance, but rather are used to distinguish one element from another. The terms “a” and “an” herein do not denote a limitation of quantity, but rather denote the presence of at least one of the referenced item. All numerals modified by “about” are inclusive of the precise numeric value unless otherwise specified.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A process for providing at least a portion of steam produced by a boiler to a regenerating system, said process comprising:
producing a steam by combusting a fuel source in a boiler;
providing at least a portion of said steam to a set of pressure turbines fluidly coupled to said boiler, said set of pressure turbines including a high pressure turbine, an intermediate pressure turbine, and a low pressure turbine;
siphoning at least a portion of said steam provided to said set of pressure turbines through a siphoning mechanism to produce siphoned steam, wherein said siphoning mechanism is located at a position selected from a group consisting of a position between said boiler and said high pressure turbine, a position between said high pressure turbine and said intermediate pressure turbine, a position between said intermediate pressure turbine and said low pressure turbine, and combinations thereof; and
utilizing said siphoned steam as a heat source for a regenerating system fluidly coupled to said siphoning mechanism.

2. A process according to claim 1, wherein said siphoning mechanism is located at a position between said boiler and said high pressure turbine.

3. A process according to claim 2, wherein said set of pressure turbines further includes a back pressure turbine, said back pressure turbine fluidly coupled to said siphoning mechanism and said regenerating system.

4. A process according to claim 1, wherein said siphoning mechanism is located between said high pressure turbine and said intermediate pressure turbine.

5. A process according to claim 4, wherein said set of pressure turbines further includes a back pressure turbine, said back pressure turbine fluidly coupled to said steam siphoning mechanism and said regenerating system.

6. A process according to claim 1, wherein said siphoning mechanism is located between said intermediate pressure turbine and said low pressure turbine.

7. A process according to claim 6, further comprising a second siphoning mechanism located between said boiler and said regenerating system.

8. A process according to claim 6, further comprising a second siphoning mechanism located between said boiler and said high pressure turbine.

9. A system for regenerating an absorbent solution, said system comprising:
steam produced by a boiler;
a set of pressure turbines fluidly coupled to said boiler, said set of pressure turbines including a high pressure turbine, an intermediate pressure turbine, and a low pressure turbine;
a siphoning mechanism for siphoning at least a portion of said steam produced by said boiler, wherein said siphoning mechanism is located at a position selected from a group consisting of a position between said boiler and said high pressure turbine, a position between said high pressure turbine and said intermediate pressure turbine, a position between said intermediate pressure turbine and said low pressure turbine, and combinations thereof; and
a regenerating system fluidly coupled to said siphoning mechanism, wherein siphoned steam is utilized as a heat source for said regenerating system.

10. A system according to claim 9, wherein said siphoning mechanism is located at a position between said boiler and said high pressure turbine.

11. A system according to claim 10, wherein said set of pressure turbines further includes a back pressure turbine, said back pressure turbine is fluidly coupled to said siphoning mechanism and said regenerating system.

12. A system according to claim 9, wherein said siphoning mechanism is located between said high pressure turbine and said intermediate pressure turbine.

13. A system according to claim 12, wherein said set of pressure turbines further includes a back pressure turbine, said back pressure turbine is fluidly coupled to said steam siphoning mechanism and said regenerating system.

14. A system according to claim 9, wherein said siphoning mechanism is located between said intermediate pressure turbine and said low pressure turbine.

15. A system according to claim 14, further comprising a second siphoning mechanism located between said boiler and said regenerating system.

16. A system according to claim 14, further comprising a second siphoning mechanism located between said boiler and said high pressure turbine.

17. A system according to claim 9, wherein said regenerating system comprises a regenerator and a reboiler.

18. A system according to claim 17, wherein said reboiler provides a steam to said regenerator, said steam regenerating a rich absorbent solution in said regenerator.

19. A system according to claim 18, wherein said rich absorbent solution comprises a chemical solvent selected from the group of monoethanolamine (MEA), diethanolamine (DEA), diisopropanolamine (DIPA), N-methylethanolamine, triethanolamine (TEA), N-methyldiethanolamine (MDEA), piperazine, N-methylpiperazine (MP), N-hydroxyethylpiperazine (HEP), 2-amino-2-methyl-1-propanol (AMP), 2-(2-aminoethoxy)ethanol, 2-(2-tert-butylaminopropoxy)ethanol, 2-(2-tert-butylaminoethoxy)ethanol (TBEE), 2-(2-tert-amylaminoethoxy)ethanol, 2-(2-isopropylaminopropoxy)ethanol, or 2-(2-(1-methyl-1-ethylpropylamino)ethoxy)ethanol.

20. A system according to claim 18, wherein said rich absorbent solution comprises ammonia.

21. In a system for regenerating an absorbent solution, the system comprising a first boiler generating a process stream and steam, an absorber for removing an acidic component from said process stream thereby forming a rich absorbent solution and a cleansed process stream, and a regenerator for regenerating said rich absorbent solution, the improvement comprising:
a second boiler generating steam; and
a reboiler coupled to said regenerator, wherein at least a portion of steam from said second boiler is provided to said reboiler.

22. A system according to claim 21, further comprising a pressure turbine coupled to said reboiler and said second boiler, wherein at least a portion of said steam from said second boiler is first provided to said pressure turbine prior and then to said reboiler.

23. A system according to claim 21, further wherein at least a portion of said steam from said second boiler is provided to a set of pressure turbines, wherein said set of pressure turbines includes a high pressure turbine, an intermediate pressure turbine and a low pressure turbine.
